(19) United States
(12) Patent Application Publication
(10) Pub. No.: US 2022/0263106 A1
(43) Pub. Date: Aug. 18, 2022

(54) FUEL CELL PRODUCING METHOD AND FUEL CELL

(71) Applicant: TOYOTA JIDOSHA KABUSHIKI KAISHA, Toyota-shi (JP)

(72) Inventors: Yusuke SHIMMYO, Nagoya-shi (JP); Kenji SATO, Kasugai-shi (JP)

(73) Assignee: TOYOTA JIDOSHA KABUSHIKI KAISHA, Toyota-shi (JP)

(21) Appl. No.: 17/651,498

(22) Filed: Feb. 17, 2022

(30) Foreign Application Priority Data
Feb. 18, 2021 (JP) 2021-023937

(51) Int. Cl. H01M 8/0286; H01M 8/1004; H01M 8/0273

(52) U.S. Cl. CPC H01M 8/0286; H01M 8/0273; H01M 8/1004

(57) ABSTRACT

A fuel cell producing method capable of securing a bonding strength required for both a membrane-electrode assembly and a resin frame having different surface textures. The fuel cell producing method includes processes of preparation, disposition, and bonding. The preparation process prepares a two-layer structured adhesive sheet as a thermoplastic adhesive having a first bonding layer and a second bonding layer. The disposition process disposes the thermoplastic adhesive between the membrane-electrode assembly and the resin frame, with the first bonding layer facing the membrane-electrode assembly and with the second bonding layer facing the resin frame. The bonding process bonds the membrane-electrode assembly and the resin frame via the thermoplastic adhesive by heating the thermoplastic adhesive to be plasticized and further decreasing a temperature of the plasticized thermoplastic adhesive to be cured.

### CROSS REFERENCE TO RELATED APPLICATIONS

The present application claims priority from Japanese patent application JP 2021-023937 filed on Feb. 18, 2021, the entire content of which is hereby incorporated by reference into this application.

### BACKGROUND

### Technical Field

The present disclosure relates to a fuel cell producing method and a fuel cell.

### Background Art

Inventions related to a fuel cell producing method have conventionally been known (JP 2020-149886 A). JP 2020-149886 A discloses a fuel cell producing method that includes a step of applying an adhesive to a membrane-electrode assembly using screen printing. A printing plate used in the screen printing has a smaller mesh diameter in its part for printing the outer side of the membrane-electrode assembly than in its part for printing the inner side of the membrane-electrode assembly (Abstract, claim 1, and paragraph 0006 of JP 2020-149886 A). Such a conventional method for producing a fuel cell stack can prevent an adhesive used in bonding a membrane-electrode assembly and a three-layer sheet together from adhering to a mounting table (paragraph 0009 of JP 2020-149886 A).

### SUMMARY

For example, when a liquid adhesive is used as in the aforementioned conventional fuel cell producing method, problems such as uneven coating of the adhesive and bubble formation in the adhesive could occur, and thus, to avoid such problems, a sheet-like thermoplastic adhesive can be conceived for use in place of the liquid adhesive. However, since a membrane-electrode assembly and a resin frame have different surface textures, when they are bonded together using a sheet-like thermoplastic adhesive, it is difficult to secure the bonding strength required for both the membrane-electrode assembly and the resin frame.

The present disclosure provides a fuel cell producing method and a fuel cell that are capable of securing a bonding strength required for both the membrane-electrode assembly and the resin frame having different surface textures.

An embodiment of the present disclosure is a method for producing a fuel cell having a membrane-electrode assembly and a resin frame bonded together via a sheet-like thermoplastic adhesive, the method for producing the fuel cell including: preparing, as the thermoplastic adhesive, a two-layer adhesive sheet having a first bonding layer and a second bonding layer, the first bonding layer having a higher bondability to the membrane-electrode assembly than to the resin frame, the second bonding layer having a higher bondability to the resin frame than to the membrane-electrode assembly; disposing the two-layer adhesive sheet between the membrane-electrode assembly and the resin frame, with the first bonding layer facing the membrane-electrode assembly and with the second bonding layer facing the resin frame; and bonding the membrane-electrode assembly and the resin frame together via the thermoplastic adhesive by heating the two-layer adhesive sheet, which is disposed between the membrane-electrode assembly and the resin frame in the disposing, to be plasticized and further decreasing a temperature of the plasticized two-layer adhesive sheet to be cured.

In the fuel cell producing method of the aforementioned embodiment, the disposing may include mounting the two-layer adhesive sheet on the membrane-electrode assembly and mounting the resin frame on the two-layer adhesive sheet mounted on the membrane-electrode assembly.

In the fuel cell producing method of the aforementioned embodiment, the first bonding layer may be formed of a thermoplastic resin containing an amide group and the second bonding layer may be formed of an olefin thermoplastic resin.

Further, an embodiment of the present disclosure is a fuel cell including a membrane-electrode assembly and a resin frame bonded together via a sheet-like thermoplastic adhesive, in which the thermoplastic adhesive is a two-layer adhesive sheet including a first bonding layer and a second bonding layer, the first bonding layer having a higher bondability to the membrane-electrode assembly than to the resin frame, the second bonding layer having a higher bondability to the resin frame than to the membrane-electrode assembly, and the membrane-electrode assembly and the resin frame are bonded together via the two-layer adhesive sheet, with the membrane-electrode assembly and the first bonding layer bonded together and with the resin frame and the second bonding layer bonded together.

According to the aforementioned embodiments of the present disclosure, a fuel cell producing method and a fuel cell that are capable of securing a bonding strength required for both the membrane-electrode assembly and the resin frame having different surface textures can be provided.

### BRIEF DESCRIPTION OF THE DRAWINGS

FIG. 1 is a schematic plan view showing an embodiment of a fuel cell according to the present disclosure;

FIG. 2 is a plan view of the fuel cell of FIG. 1 from which a separator is removed;

FIG. 3 is an enlarged cross-sectional view of the fuel cell taken along line of FIG. 1;

FIG. 4 is a flowchart showing an embodiment of a fuel cell producing method according to the present disclosure; and

FIG. 5 is a flowchart showing the details of a disposition process in the fuel cell producing method of FIG. 4.

### DETAILED DESCRIPTION

The following will describe embodiments of a fuel cell producing method and a fuel cell according to the present disclosure with reference to the drawings. The embodiment of the fuel cell according to the present disclosure will be described first, followed by the description of the fuel cell producing method.

(Fuel Cell)

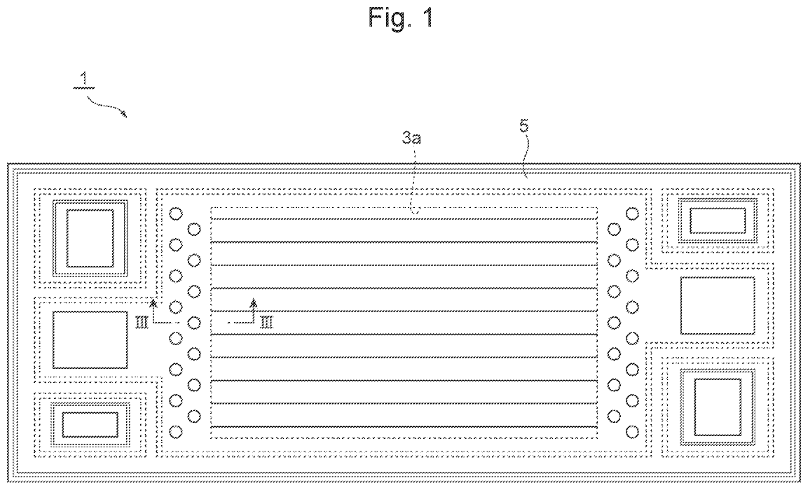

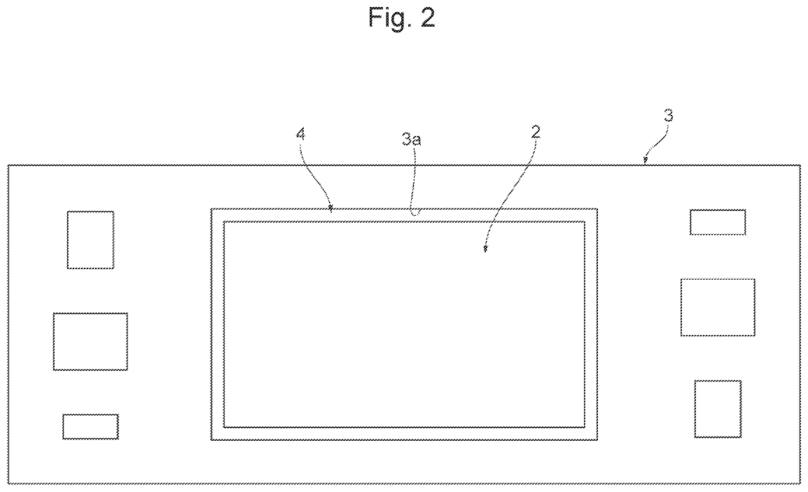

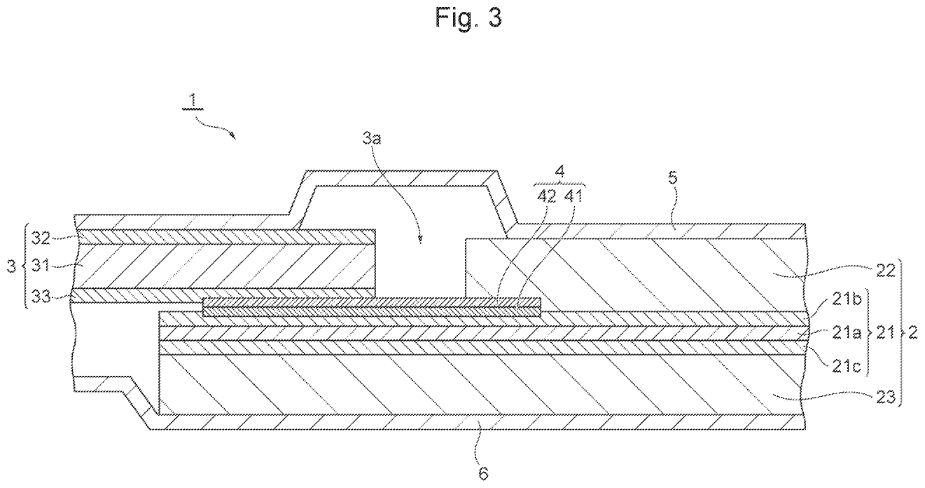

FIG. 1 is a schematic plan view showing an embodiment of a fuel cell 1 according to the present disclosure. FIG. 2 is a plan view of the fuel cell 1 of FIG. 1 from which a separator 5 is removed. FIG. 3 is an enlarged cross-sectional view of the fuel cell 1 taken along line of FIG. 1.

The fuel cell 1 includes, for example, a membrane-electrode and gas diffusion layer assembly (hereinafter abbreviated as “MEGA”) 2, a resin frame 3, a thermoplastic adhesive 4, a cathode side separator 5, and an anode side separator 6. Though not shown, a plurality of fuel cells 1 are stacked to form a fuel cell stack and the fuel cell stack is used to produce a fuel battery.

The MEGA 2 includes a membrane-electrode assembly (hereinafter abbreviated as “MEA”) 21, a cathode side gas diffusion layer (hereinafter abbreviated as “GDL”) 22, and an anode side GDL 23.

The MEA 21 includes an electrolyte membrane 21a, a cathode side catalyst layer 21b, and an anode side catalyst layer 21c. The cathode side catalyst layer 21b is bonded to one side of the electrolyte membrane 21a and the anode side catalyst layer 21c is bonded to the other side of the electrolyte membrane 21a.

The electrolyte membrane 21a is formed of, for example, a polyelectrolyte resin that is a solid polymer, such as a perfluorosulfonic acid (PFSA) ionomer, and is an ion-exchange membrane having an ion-conductive polymer membrane as the electrolyte. The electrolyte membrane 21a functions to block the passages of electrons and gas and to move protons from the anode side catalyst layer 21c to the cathode side catalyst layer 21b.

The cathode side catalyst layer 21b is bonded to the cathode side GDL 22 via an adhesive. The cathode side catalyst layer 21b includes a conductive carrier that supports a catalyst such as platinum and a platinum alloy. For example, the cathode side catalyst layer 21b is an electrode catalyst layer formed by coating carbon particles, such as those supporting a catalyst, with a proton-conductive ionomer.

The ionomer is formed of a polyelectrolyte resin that is a solid polymer, such as a fluorine resin having a property equivalent to that of the electrolyte membrane 21a. The ionomer includes an ion-exchange group, thus having a proton conductivity. The cathode side catalyst layer 21b functions to produce water from protons, electrons, and oxygen.

The anode side catalyst layer 21c is formed of a similar material as that of the cathode side catalyst layer 21b. Unlike the cathode side catalyst layer 21b, the anode side catalyst layer 21c functions to decompose a hydrogen gas (H₂) into protons and electrons. The anode side catalyst layer 21c is formed larger than the cathode side catalyst layer 21b and is stacked facing the resin frame 3 across the electrolyte membrane 21a. Further, the anode side catalyst layer 21c is stacked facing the cathode side GDL 22 via the electrolyte membrane 21a and the cathode side catalyst layer 21b.

The cathode side GDL 22 is formed of a gas-permeable and conductive material, for example, a porous fiber substrate including carbon fibers such as a carbon paper, graphite fibers, and the like. The cathode side GDL 22 is bonded to the outer side of the cathode side catalyst layer 21b and functions to uniformly diffuse air as an oxidant gas to be spread throughout the cathode side catalyst layer 21b.

As with the cathode side GDL 22, the anode side GDL23 is formed of a gas-permeable and conductive material, for example, a porous fiber substrate including carbon fibers such as a carbon paper, graphite fibers, and the like. The anode side GDL23 is bonded to the outer side of the anode side catalyst layer 21c and functions to uniformly diffuse a hydrogen gas as a fuel gas to be spread throughout the anode side catalyst layer 21c.

As shown in FIG. 2, for example, the resin frame 3 is in a rectangular form having a rectangular opening 3a in its midsection. As shown in FIG. 3, for example, the resin frame 3 is a three-layer structured sheet including a core material 31, an adhesive layer 32 formed on one side of the core material 31, and an adhesive layer 33 formed on the other side of the core material 31.

Examples of the material that may be used for the core material 31 include a thermoplastic synthetic resin, such as polyethylene naphthalate (PEN) and polyethylene terephthalate (PET). The adhesive layers 32 and 33 have higher rigidity, elasticity, and viscosity than the electrolyte membrane 21a, for example. Examples of the material that may be used for the adhesive layers 32 and 33 include an adhesive formed of polypropylene (PP) or an epoxy resin.

The resin frame 3 is bonded to the cathode side separator 5 via the adhesive layer 32 as one adhesive layer and to the anode side separator 6 via the adhesive layer 33 as the other adhesive layer. Further, the resin frame 3 is bonded, via the thermoplastic adhesive 4, to the MEA 21 exposed in an end portion of the MEGA 2. The resin frame 3 prevents cross leaks and electrical short circuits between catalyst electrodes. The cross leak is a phenomenon that gases such as a hydrogen gas (H₂) at the fuel electrode and an oxygen gas (O₂) at the air electrode leak in a minute amount through the electrolyte membrane 21a.

The thermoplastic adhesive 4 is disposed, for example, between the MEA 21 and the resin frame 3 so as to bond the MEA 21 and the resin frame 3 together. The thermoplastic adhesive 4 is provided, for example, in a rectangular or a frame shape corresponding to the shape of the opening 3a of the resin frame 3. As shown in FIG. 3, the outer edge portion of the thermoplastic adhesive 4 is positioned in a region on the outer side of the opening 3a of the resin frame 3 and the inner edge portion of the thermoplastic adhesive 4 is positioned in a region on the inner side of the opening 3a of the resin frame 3.

The thermoplastic adhesive 4 covers the MEA 21 exposed in the outer edge portion of the MEGA 2. More specifically, the outer edge portion of the MEGA 2 is a portion on the outer side of the power generation portion of the MEGA 2 disposed on the inner side of the opening 3a of the resin frame 3. In the outer edge portion of the MEGA 2, the cathode side GDL 22 is removed so that the cathode side catalyst layer 21b of the MEA 21 is exposed.

The thermoplastic adhesive 4 extends, for example, from the inner side of the power generation portion of the MEGA 2, which is a region on the inner side of the opening 3a of the resin frame 3, to the outer edge portion of the MEGA 2 on the outer side of the power generation portion, where the cathode side gas diffusion layer 22 is removed. In this manner, the thermoplastic adhesive 4 covers the entire surface of the cathode side catalyst layer 21b of the MEA 21, exposed in the outer edge portion of the MEGA 2, inside of the opening 3a of the resin frame 3.

The thermoplastic adhesive 4 is, for example, a two-layer structured adhesive sheet including a first bonding layer 41 and a second bonding layer 42. The thermoplastic adhesive 4 is in a sheet form before being heated to be plasticized, for example. The resin frame 3 and the MEA 21 are heat-sealed via the thermoplastic adhesive 4 such that the thermoplastic adhesive 4 disposed between the resin frame 3 and the MEA 21 is heated to be plasticized and then cured by decreasing its temperature.

The first bonding layer 41 of the thermoplastic adhesive 4 has a higher bondability to the MEA 21 than to the resin frame 3. Specifically, for example, the first bonding layer 41 has a higher bondability to the cathode side catalyst layer 21b of the MEA 21 than to the adhesive layer 33 of the resin frame 3. The first bonding layer 41 is formed of, for example, a thermoplastic resin containing an amide group that tends to join to a sulfone group. More specifically, the first bonding layer 41 includes a polyamide (nylon) resin material as the main material, for example.

The second bonding layer 42 of the thermoplastic adhesive 4 has a higher bondability to the resin frame 3 than to the MEA 21. Specifically, for example, the second bonding layer 42 has a higher bondability to the adhesive layer 33 of the resin frame 3 than to the cathode side catalyst layer 21b of the MEA 21. The second bonding layer 42 is formed of, for example, an olefin thermoplastic resin. More specifically, the second bonding layer 42 includes a resin material, such as polyethylene and polypropylene, as the main material, for example. Note that the method for bonding the first bonding layer 41 and the second bonding layer 42 together is not particularly limited.

The cathode side separator 5 is formed of a metal plate, such as a steel plate, a stainless-steel plate, and an aluminum plate. The cathode side separator 5 is bonded to the cathode side GDL 22 and the resin frame 3 so as to form an oxidant gas channel for flowing air as an oxidant gas along the surface of the cathode side GDL 22. The cathode side separator 5 has formed on its surface a titanium (Ti) thin film on which a carbon layer is formed.

As with the cathode side separator 5, the anode side separator 6 is formed of a metal plate, such as a steel plate, a stainless-steel plate, and an aluminum plate. The anode side separator 6 is bonded to the anode side GDL23 and the resin frame 3 so as to form a fuel gas channel for flowing hydrogen as a fuel gas along the surface of the anode side GDL 23. As with the cathode side separator 5, the anode side separator 6 has formed on its surface a titanium (Ti) thin film on which a carbon layer is formed.

(Fuel Cell Producing Method)

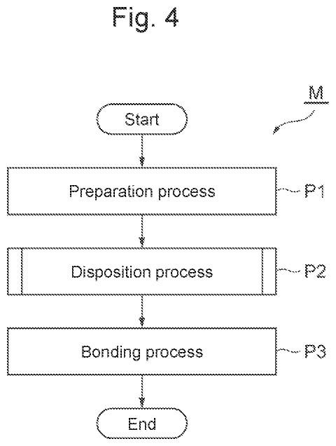

FIG. 4 is a flowchart showing an embodiment of a fuel cell producing method according to the present disclosure. A fuel cell producing method M of the present embodiment is a method for producing the fuel cell 1 including the MEA 21 and the resin frame 3 bonded together via the sheet-like thermoplastic adhesive 4. The fuel cell producing method M of the present embodiment includes a preparation process P1, a disposition process P2, and a bonding process P3.

The preparation process P1 prepares a two-layer structured adhesive sheet as the thermoplastic adhesive 4. As described above, the thermoplastic adhesive 4 in the form of a two-layer adhesive sheet includes the first bonding layer 41 having a higher bondability to the MEA 21 than to the resin frame 3 and the second bonding layer 42 having a higher bondability to the resin frame 3 than to the MEA 21. Once the preparation process P1 ends upon completion of the preparation of the thermoplastic adhesive 4, the disposition process P2 is implemented.

The disposition process P2 disposes the thermoplastic adhesive 4 in the form of a two-layer adhesive sheet between the MEA 21 and the resin frame 3. The disposition process P2 disposes the thermoplastic adhesive 4 between the MEA 21 and the resin frame 3, with the first bonding layer 41 facing the MEA 21 and with the second bonding layer 42 facing the resin frame 3.

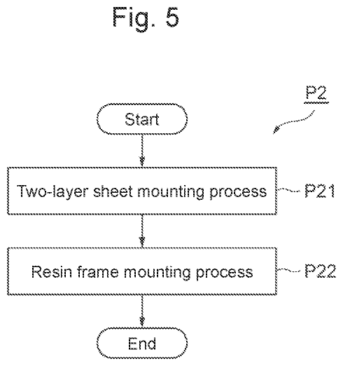

FIG. 5 is a flowchart showing an example of the disposition process P2 of the fuel cell producing method M of FIG. 4. The disposition process P2 includes, for example, a process P21 of mounting the thermoplastic adhesive 4 in the form of a two-layer adhesive sheet on the MEA 21 and a process P22 of mounting the resin frame 3 on the thermoplastic adhesive 4 in the form of a two-layer adhesive sheet that is mounted on the MEA 21. In this manner, the thermoplastic adhesive 4 in the form of a two-layer adhesive sheet is disposed between the MEA 21 and the resin frame 3. Once the disposition process P2 ends, the bonding process P3 is implemented.

The bonding process P3 bonds the MEA 21 and the resin frame 3 together via the thermoplastic adhesive 4. In this bonding process P3, the thermoplastic adhesive 4 in the form of a two-layer adhesive sheet, which is disposed between the MEA 21 and the resin frame 3 in the disposition process P2, is heated to be plasticized, and further, the plasticized two-layer adhesive sheet is cured by decreasing its temperature. In this manner, the MEA 21 and the resin frame 3 are heat-sealed to be bonded together via the thermoplastic adhesive 4.

Subsequently, the cathode side GDL 22 of the MEGA 2 to which the resin frame 3 is bonded via the thermoplastic adhesive 4 is made to face the cathode side separator 5 and the anode side GDL23 of the MEGA 2 is made to face the anode side separator 6. Then, the MEGA 2, the cathode side separator 5, and the anode side separator 6 are bonded together so that the fuel cell 1 is produced.

The following will describe the effects of the fuel cell producing method M and the fuel cell 1 of the present embodiments.

The aforementioned conventional fuel cell producing method described in JP 2020-149886 A bonds the membrane-electrode assembly and the resin frame together using a liquid adhesive. However, use of the liquid adhesive could cause uneven coating or bubble formation in the adhesive. Further, due to uneven coating or bubbles formed in the adhesive, the adhesive could become partially defective, causing cross leaks or lowering durability of the membrane-electrode assembly.

As a solution to such problems, a sheet-like thermoplastic adhesive may be conceived for use in place of a liquid adhesive. However, since the membrane-electrode assembly and the resin frame have different surface textures, when they are bonded together using the sheet-like thermoplastic adhesive, it is difficult to secure the bonding strength required for both the membrane-electrode assembly and the resin frame.

Meanwhile, the fuel cell producing method M of the present embodiment is a method for producing the fuel cell 1 including the MEA 21 and the resin frame 3 bonded together via the sheet-like thermoplastic adhesive 4, as described above. The fuel cell producing method M includes the preparation process P1, the disposition process P2, and the bonding process P3, as described above. The preparation process P1 prepares, as the thermoplastic adhesive 4, the two-layer adhesive sheet including the first bonding layer 41 having a higher bondability to the MEA 21 than to the resin frame 3 and the second bonding layer 42 having a higher bondability to the resin frame 3 than to the MEA 21. The disposition process P2 disposes the thermoplastic adhesive 4 between the MEA 21 and the resin frame 3, with the first bonding layer 41 facing the MEA 21 and with the second bonding layer 42 facing the resin frame 3. The bonding process P3 bonds the MEA 21 and the resin frame 3 together via the thermoplastic adhesive 4 by heating the thermoplastic adhesive 4, which is disposed between the MEA 21 and the resin frame 3 in the disposition process P2, to be plasticized and further curing the plasticized thermoplastic adhesive 4 by decreasing its temperature.

According to the fuel cell producing method M of the present embodiment, the MEA 21 and the resin frame 3 are heat-sealed to be bonded together via the sheet-like thermoplastic adhesive 4, so that the adhesive can be prevented from becoming defective, which could occur when a liquid adhesive is used. Thus, the fuel cell producing method M of the present embodiment can more surely prevent the cross leak, thereby improving the durability of the MEA 21 as compared to bonding the MEA 21 and the resin frame 3 using a liquid adhesive.

Further, as described above, the fuel cell producing method M of the present embodiment uses, as the thermoplastic adhesive 4, the two-layer adhesive sheet including the first bonding layer 41 having a higher bondability to the MEA 21 and the second bonding layer 42 having a higher bondability to the resin frame 3. Thus, the thermoplastic adhesive 4 can secure the bonding strength required for both the MEA 21 and the resin frame 3 having different surface textures. Therefore, the fuel cell producing method M of the present embodiment can provide electrically insulating sealing by tightly bonding the thermoplastic adhesive 4 to both the MEA 21 and the resin frame 3.

Furthermore, in the fuel cell producing method M of the present embodiment, the disposition process P2 includes the process P21 of mounting the thermoplastic adhesive 4 in the form of a two-layer adhesive sheet on the MEA 21 and the process P22 of mounting the resin frame 3 on the thermoplastic adhesive 4 that is mounted on the MEA 21. Such a configuration facilitates disposing the thermoplastic adhesive 4 between the MEA 21 and the resin frame 3, with the first bonding layer 41 of the thermoplastic adhesive 4 facing the MEA 21 and with the second bonding layer 42 of the thermoplastic adhesive 4 facing the resin frame 3.

Further, in the fuel cell producing method M of the present embodiment, the first bonding layer 41 of the thermoplastic adhesive 4 is formed of a thermoplastic resin containing an amide group and the second bonding layer 42 of the thermoplastic adhesive 4 is formed of an olefin thermoplastic resin. Such a configuration can firmly bond the first bonding layer 41 of the thermoplastic adhesive 4 to the MEA 21, and the second bonding layer 42 of the thermoplastic adhesive 4 to the resin frame 3. Therefore, the fuel cell producing method M of the present embodiment can prevent the resin frame 3 and the MEA 21 from being separated from each other.

Further, the fuel cell 1 of the present embodiment includes the MEA 21 and the resin frame 3 bonded together via the sheet-like thermoplastic adhesive 4. The thermoplastic adhesive 4 is a two-layer adhesive sheet including the first bonding layer 41 having a higher bondability to the MEA 21 than to the resin frame 3 and the second bonding layer 42 having a higher bondability to the resin frame 3 than to the MEA 21. The fuel cell 1 includes the MEA 21 and the resin frame 3 bonded together via the thermoplastic adhesive 4 in the form of a two-layer adhesive sheet, with the MEA 21 and the first bonding layer 41 bonded together and with the resin frame 3 and the second bonding layer 42 bonded together.

According to the fuel cell 1 of the present embodiment, the MEA 21 and the resin frame 3 are heat-sealed to be bonded together via the sheet-like thermoplastic adhesive 4, so that the adhesive can be prevented from becoming defective, which could occur when a liquid adhesive is used. Thus, the fuel cell 1 of the present embodiment can more surely prevent the cross leak, thereby improving the durability of the MEA 21 as compared to bonding the MEA 21 and the resin frame 3 using a liquid adhesive.

Further, as described above, the fuel cell 1 of the present embodiment uses, as the thermoplastic adhesive 4, the two-layer adhesive sheet including the first bonding layer 41 having a higher bondability to the MEA 21 and the second bonding layer 42 having a higher bondability to the resin frame 3. Thus, the thermoplastic adhesive 4 can secure the bonding strength required for both the MEA 21 and the resin frame 3 having different surface textures. Therefore, the fuel cell 1 of the present embodiment can provide electrically insulating sealing by tightly bonding the thermoplastic adhesive 4 to both the MEA 21 and the resin frame 3.

Further, in the fuel cell 1 of the present embodiment, the cathode side catalyst layer 21b of the MEA 21 is exposed in the outer edge portion of the MEGA 2, and the exposed cathode side catalyst layer 21b is covered with the thermoplastic adhesive 4. In this manner, the cathode side catalyst layer 21b that produces more water is covered with the thermoplastic adhesive 4, so that the hydrolysis of the amide bond and swelling of the MEA 21 are suppressed, thereby improving the durability of the MEGA 2.

As described above, the present embodiments can provide the fuel cell producing method M and the fuel cell 1 that are capable of securing the bonding strength required for both the MEA 21 and the resin frame 3 having different surface textures.

Although the embodiments of the fuel cell producing method and the fuel cell according to the present disclosure have been described in detail with reference to the drawings, the specific configurations are not limited thereto, and any design changes in the scope without departing from the spirit of the present disclosure are included in the present disclosure.

### DESCRIPTION OF SYMBOLS

1 Fuel cell
21 Membrane electrode assembly (MEA)
3 Resin frame
4 Thermoplastic adhesive (two-layer adhesive sheet)
41 First bonding layer
42 Second bonding layer
M Fuel cell producing method
P1 Preparation process
P2 Disposition process
P21 Process of mounting two-layer adhesive sheet
P22 Process of mounting resin frame
P3 Bonding process

What is claimed is:

1. A method for producing a fuel cell having a membrane-electrode assembly and a resin frame bonded together via a sheet-like thermoplastic adhesive, the method for producing the fuel cell comprising:
preparing, as the thermoplastic adhesive, a two-layer adhesive sheet having a first bonding layer and a second bonding layer, the first bonding layer having a higher bondability to the membrane-electrode assembly than to the resin frame, the second bonding layer having a higher bondability to the resin frame than to the membrane-electrode assembly;
disposing the two-layer adhesive sheet between the membrane-electrode assembly and the resin frame, with the first bonding layer facing the membrane-electrode assembly and with the second bonding layer facing the resin frame; and
bonding the membrane-electrode assembly and the resin frame together via the thermoplastic adhesive by heating the two-layer adhesive sheet, which is disposed between the membrane-electrode assembly and the resin frame in the disposing, to be plasticized and further decreasing a temperature of the plasticized two-layer adhesive sheet to be cured.

2. The method for producing a fuel cell according to claim 1, wherein the disposing comprises mounting the two-layer adhesive sheet on the membrane-electrode assembly and mounting the resin frame on the two-layer adhesive sheet mounted on the membrane-electrode assembly.

3. The method for producing a fuel cell according to claim 1, wherein the first bonding layer is formed of a thermoplastic resin containing an amide group and the second bonding layer is formed of an olefin thermoplastic resin.

4. A fuel cell comprising a membrane-electrode assembly and a resin frame bonded together via a sheet-like thermoplastic adhesive, wherein
the thermoplastic adhesive is a two-layer adhesive sheet including a first bonding layer and a second bonding layer, the first bonding layer having a higher bondability to the membrane-electrode assembly than to the resin frame, the second bonding layer having a higher bondability to the resin frame than to the membrane-electrode assembly, and
the membrane-electrode assembly and the resin frame are bonded together via the two-layer adhesive sheet, with the membrane-electrode assembly and the first bonding layer bonded together and with the resin frame and the second bonding layer bonded together.
